(19) United States
(12) Patent Application Publication
(10) Pub. No.: US 2006/0041045 A1
(43) Pub. Date: Feb. 23, 2006

(54) Graftable 4-amino-3-sulfinyl-substituted diphenylamine stabilizers for vulcanizates

(76) Inventors: Hans-Rudolf Meier, Basel (CH); Gerrit Knobloch, Magden (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/529,414

(22) PCT Filed: Sep. 30, 2003
(86) PCT No.: PCT/EP03/10836

§ 371 Date: Mar. 29, 2005

(30) Foreign Application Priority Data
Oct. 7, 2002 (EP) 02405864.6

(51) Int. Cl. C08K 5/41

(52) U.S. Cl. 524/155

(57) ABSTRACT

Compounds of the formula (I) wherein R₁ is C₁-C₁₈alkyl, C₅-C₁₂-cycloalkyl, phenyl, benzyl, or allyl; n is 1 or 2; if n is 1, R₂ is C₄-C₁₈alkyl, C₅-C₁₂cycloalkyl, aryl or heteroaryl, benzyl, allyl, (CH₂),ₘCOOR₃, or is (CH₂)ₘCN; if n is 2, R₂ is —S—(CH₂)ₚ—S or —S—(CH₂)₂—[O—(CH₂)₂]ₘ—S R₃ is C₁-C₁₈alkyl, benzyl, allyl; m is 1 or 2; and p is a number from 2 to 12; are suitable as a stabiliser for an elastomer to prevent oxidative, thermal, dynamic, light-induced and/or ozoneinduced degradation. They are also suitable as stabilizers for elastomers to prevent contact discoloration of substrates coming into contact with elastomers.

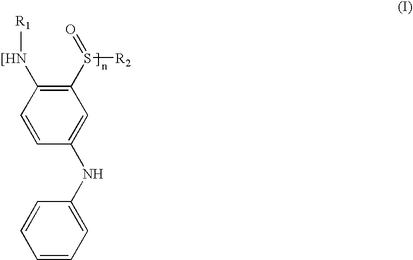

The present invention relates to novel stabilizers of the 4-amino-3-sulfinyl-diphenylamine type, to compositions comprising an elastomer susceptible to oxidative, thermal, dynamic, or light- and/or ozone-induced degradation and, as stabilizer, at least one compound of the 4-amino-3-sulfinyl-diphenylamine type, to the use of the stabilizers to prevent discoloration of a substrate coming into contact with elastomers, and as antiozonants for elastomers to prevent oxidative, thermal, dynamic, or light- and/or ozone-induced degradation, and also to the corresponding processes, and to a process for grafting the stabilizing onto elastomers.

Elastomers such as rubber products (vulcanizates), like all polymers, are susceptible to oxidative, thermal, dynamic or light-induced degradation. A particular factor causing damage to diene rubber vulcanizates is ozone. Ozone attacks the carbon-carbon double bonds, of which many remain in the rubber (vulcanizate), and, via the mechanism known as ozonolysis, causes damage which is apparent as typical surface cracking, and failure of the rubber product. The damage is particularly serious when the rubber product is under dynamic stress.

To prevent ozone damage, antioxidants selected from the class consisting of para-phenylenediamines [see Russel A. Mazzeo et al., “Tire Technology International” 1994, pp. 36-46; or Donald E. Miller et al., Rubber World, 200 (5), 13-23 (1989)] are generally added to vulcanizates. These compounds have very good protective action, especially under dynamic conditions, but develop a strong intrinsic colour (discolouring) and, as a result of high migration rate, these compounds give severe contact discoloration (staining), i.e. the dye transfers to other substrates/products on direct contact. This means that the stabilizers employed in the prior art cannot be used as stabilizers for rubber products which are free from carbon black or are “non-black”, and they are also unsuitable for (black) rubber products which comprise carbon black and are intended for use in direct contact with pale-coloured products.

There continues to be a need for stabilizers which, although they may have an intrinsic colour, are unable, for example as a result of chemical bonding to the rubber chains, to transfer the colour to other products.

It has now been found that compounds of the 4-amino-3-sulfinyl-diphenylamine type are particularly suitable as stabilizers for elastomers susceptible to oxidative, thermal, dynamic, or light- and/or ozone-induced degradation.

The present invention therefore provides compounds of the formula I 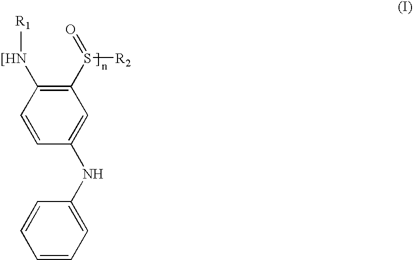
wherein
R₁ is C₁-C₁₈alkyl, C₅-C₁₂-cycloalkyl, phenyl, benzyl, or allyl;
n is 1 or 2;
if n is 1, R₂ is C₄-C₁₈alkyl, C₅-C₁₂-cycloalkyl, aryl or heteroaryl, benzyl, allyl, (CH₂)ₘCOOR₃, or
is (CH₂)ₘCN;
if n is 2, R₂ is —S—(CH₂)ₚ—S or —S—(CH₂)₂—[O—(CH₂)₂]ₘ—S—
R₃ is C₁-C₁₈alkyl, benzyl, allyl;
m is 1 or 2; and
p is a number from 2 to 12.

Preferred compound of formula I are those wherein
R₁ is C₂-C₈-alkyl, cyclohexyl, phenyl, benzyl, or allyl; especially 2-propyl, —CH(CH₃)—CH₂—CH(CH₃)₂, —CH(CH₃)—CH(CH₃)₂, 2-octyl, cyclohexyl;
if n is 1, R₂ is C₄-C₁₈alkyl, cyclohexyl, phenyl, benzyl, (CH₂)₂COOR₃, or is (CH₂)₂CN;
if n is 2, R₂ is —S—(CH₂)ₚ—S— with p ranging from 2 to 6, or is —S—(CH₂)₂—O—(CH₂)₂—S—;
   especially those wherein n is 1 and R₂ is alkyl, cyclohexyl, (CH₂)₂COOR₃ or (CH₂)₂CN, most preferred R₂ being n-octyl, t-nonyl, n-dodecyl, t-dodecyl; and R₃ being C₁-C₁₈alkyl, especially i-octyl, i-tridecyl, n-dodecyl, stearyl.

Alkyl having up to 18 carbon atoms is a branched or unbranched radical, such as methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetra-methylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexa-methylhexyl, tridecyl, tetradecyl, pentadecyl, hexadecyl, heptadecyl, octadecyl. One of the preferred meanings of R₂ is C₄-C₁₈alkyl, in particular C₆-C₁₂alkyl, e.g. C₈-C₁₂alkyl.

Aryl or heteroaryl are preferably phenyl, naphthyl or pyridyl, especially phenyl.

Tert-butyl stands for 1,1-dimethylethyl; longer alkyl residues denoted as tert- or t-alkyl such as t-nonyl or t-dodecyl stand for technical isomer mixtures of tertiary alkyl groups —C(RR′R″) wherein each of R, R′ and R″ is alkyl, the total carbon number being as indicated.

Residues i-octyl or i-tridecyl are technical isomer mixtures of primary alkyl groups (commercially available e.g. from Phillips Petroleum).

Examples for compounds of the formula I are:

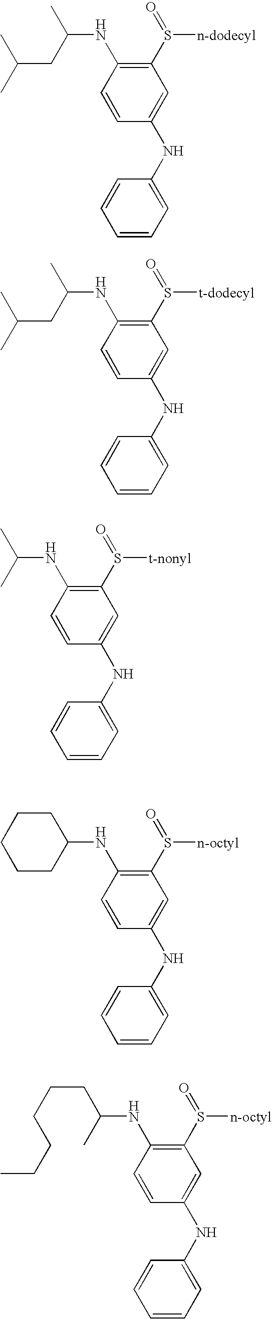

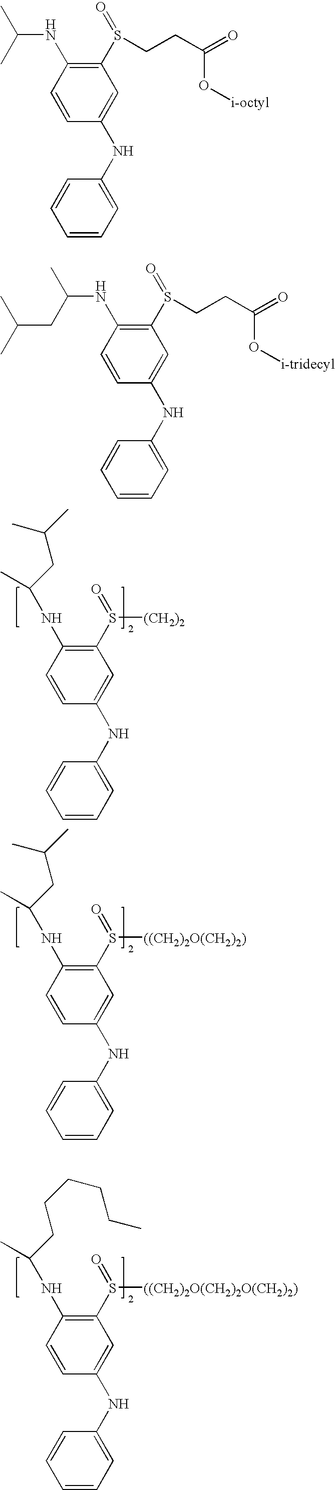

Compounds of the formula I may, for example, be obtained by known methods, for example, from the corresponding thioethers of formula II 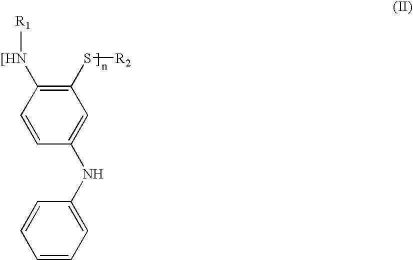
where n, R₁ and R₂ are as defined for formula (I), by oxidation, usually with an organic or anorganic peroxide or peracid. Examples are H₂O₂, H₂O₂-urea adduct, t-butylhydroperoxide, cumylhydroperoxide, performic acid, peracetic acid (or a combination of H₂O₂ /acetic acid), trichloro-peracetic acid, m-Chloroperbenzoic acid. Reactions are preferentially carried out in an organic solvent, preferably a polar solvent such as alcohol, ether, a ketone or mixtures thereof. Examples for suitable solvents are ethanol, 2-propanol, (poly)ethylene glycol, (poly)-ethylene glycol ethers, acetone, methyl-ethyl-ketone, methyl-isobutyl-ketone. Temperature is usually between −5 and +80° C., and preferentially ranges from 35 to 50° C. The amount of oxidant can be substoichiometric, stoichimometric or an excess. An excess of the oxidant can be destroyed be an appropriate method, e.g. washing with water or an organic or inorganic reducing agent such as sodium pyrosulfate. Further purification of the crude sulfoxide, e.g. with flash chromatography, is optional.

Some of the compounds of the formula II are known from WO-A-02/42262; others may be obtained in analogous manner by reacting the appropriate quinone diimine and thiol. Thus educt thioethers are obtained by reacting a quinone diimine of formula III 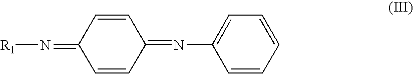
with a thiol of the formula IV
R₂—(SH)ₙ (IV)
wherein n, R₁ and R₂ are as defined for formula (I).

Reaction conditions often are similar to those described above for the oxidation step with presence of an organic solvent and temperatures conveniently within the range −5 to about 100° C.

The invention also provides some novel thioethers of formula II′ 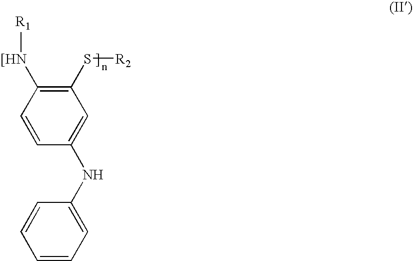
wherein n is 1 or 2,
R₁ is C₁-C₁₈alkyl, C₅-C₁₂-cycloalkyl, phenyl, benzyl, or allyl; and
R₂, if n is 1, is tert-nonyl or tert-dodecyl or (CH₂)₂COOR₃ or (CH₂)₂CN, where R₃ is
C₁-C₁₈alkyl, especially i-octyl, i-tridecyl, n-dodecyl, stearyl; or
R₂, if n is 2, is —S—(CH₂)ₚ—S— with p ranging from 2 to 6; with the proviso that the compound of the formula II′a 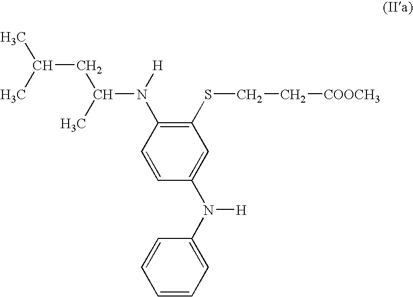
   is excluded.

Preferred compounds of the formula II′ are those wherein
n is 1 or 2, especially 1,
R₁ is 2-propyl, —CH(CH₃)—CH₂—CH(CH₃)₂, —CH(CH₃)—CH(CH₃)₂, 2-octyl or cyclohexyl, especially 2-propyl, and
R₂, if n is 1, is t-nonyl or t-dodecyl or (CH₂)₂COOR₃, where R₃ is branched C₄-C₁₈alkyl, especially i-octyl, i-tridecyl; or
R₂, if n is 2, is —S—(CH₂)ₚ—S— with p ranging from 2 to 6.

Some compounds of formula II′ of particular technical interest are those wherein n is 1 and
a) R₁ is —CH(CH₃)—CH₂—CH(CH₃)₂ and R₂ is t-dodecyl;
b) R₁ is —CH(CH₃)—CH₂—CH(CH₃)₂ and R₂ is CH₂CH₂COO-i-octyl;
c) R₁ is —CH(CH₃)—CH₂—CH(CH₃)₂ and R₂ is t-nonyl;
d) R₁ is 2-propyl and R₂ is t-dodecyl;
e) R₁ is 2-propyl and R₂ is t-nonyl.

Component b) is suitable for stabilizing elastomers, in particular pale-coloured elastomers, to prevent oxidative, thermal, dynamic, or light- and/or ozone-induced degradation.

Elastomers are to be understood as meaning macromolecular materials which after considerable deformation under a small load at room temperature rapidly regain approximately their original shape. See also Hans-Georg Elias, “An Introduction to Polymer Science”, Section 12. “Elastomers”, pp. 388-393, 1997, VCH Verlagsgesellschaft mbH, Weinheim, Germany or “Ullmann's Encyclopedia of Industrial Chemistry, fifth, completely revised edition, Volume A 23”, pp. 221-440 (1993).

Examples of elastomers which may be present in the compositions of the invention are the following materials:
1. Polymers of diolefins, for example polybutadiene or polyisoprene.
2. Copolymers of mono- and diolefins with one another or with other vinyl monomers, e.g. propylene-isobutylene copolymers, propylene-butadiene copolymers, isobutylene-isoprene copolymers, ethylene-alkyl acrylate copolymers, ethylene-alkyl methacrylate copolymers, ethylene-vinyl acetate copolymers, acrylonitrile-butadiene copolymers, and also terpolymers of ethylene with propylene and with a diene, such as hexadiene, dicyclopentadiene or ethylidenenorbomene.
3. Copolymers of styrene or α-methylstyrene with dienes or with acrylic derivatives, e.g. styrene-butadiene, styrene-butadiene-alkyl acrylate and styrene-butadiene-alkyl methacrylate; block copolymers of styrene, e.g. styrene-butadiene-styrene, styrene-isoprene-styrene and styrene-ethylenebutylene-styrene, and also adhesives prepared from the latter three.
4. Halogen-containing polymers, e.g. polychloroprene, chlorinated rubber, chlorinated or brominated copolymer of isobutylene-isoprene (halobutyl rubber).
5. Natural rubber.
6. Aqueous emulsions of natural or synthetic rubbers, e.g. natural rubber latex or latices of carboxylated styrene-butadiene copolymers.

The elastomers to be protected are preferably vulcanized elastomers. Of particular interest are natural rubber and synthetic rubber, and vulcanizates prepared therefrom. Particular preference is given to polydiene vulcanizates, halogen-containing polydiene vulcanizates, polydiene copolymer vulcanizates, in particular styrene-butadiene copolymer vulcanizates, and ethylene-propylene terpolymer vulcanizates.

Component b) is usefully added to the elastomer to be stabilized in amounts of from 0.05 to 10%, for example from 0.1 to 5%, preferably from 0.5 to 3.0%, based on the weight of the elastomer to be stabilized.

In addition to components a) and b), the compositions of the invention may comprise other additives, such as the following:

1. Antioxidants

1.1. Alkylated monophenols, for example 2,6-di-tert-butyl-4-methylphenol, 2-tert-butyl-4,6-di-methylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, nonylphenols which are linear or branched in the side chains, for example 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2. Alkylthiomethylphenols, for example 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol.

1.3. Hydroquinones and alkylated hydroquinones, for example 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4. Tocopherols, for example α-tocopherol, β-tocopherol, γ-tocopherol, δ-tocopherol and mixtures thereof (vitamin E).

1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.

1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butyl-phenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis-(5-tert-butyl-4-hydroxy2-methylphenyl)-4-n-dodecylmercaptobutane, 1,1,5,5-tetra(5-tert-butyl-4-hydroxy-2-methylphenyl)pentane.

1.7. O—, N— and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxy-benzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hydroxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-te-tramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetrame-thylbenzene, 2,4,6-tris(3,5-di-tert-butyl-4-hydroxybenzyl)phenol.
1.10. Triazine comnounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris-(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris-(3,5-di-tert-butyl-4-hydroxyphenylethyl)-1,3,5-triazine, 1,3,5-tris(3,5-di-tert-butyl-4-hydroxy-phenylpropionyl)-hexahydro-1,3,5-triazine, 1,3,5-tris(3,5-dicyclohexyl-4-hydroxybenzyl)isocyanurate.

1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.

1.12. Acylaminophenols, for example 4-hydroxylauranilide, 4-hydroxystearanilide, octyl N-(3,5-di-tert-butyl-4-hydroxyphenyl)carbamate.

1.13. Esters of β-(3.5-di-tert-butyl-4-hydroxyphenyl)Prorionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14. Esters of β-(5-tert-butyl-4-hydroxy-3-methylphenyl)pronionic acid with mono- or poly-hydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tertbutyl-4-hydroxy-5-methylphenyl)propionyloxy}-1,1-dimethylethyl]-2,4,8,10-tetraoxaspiro[5.5]-undecane.

1.15. Esters of β-(3.5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16. Esters of 3.5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17. Amides of β-(3,5-di-tert-butyl-4-hvdroxyphenyl)propionic acid e.g. N,N′-bis(3,5-di-tertbutyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Uniroyal).

1.18. Ascorbic acid (vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenyl-amine, N-phenyl-1-naphthylamine, N-(4-tert-octylphenyl)-1-naphthylamine, N-phenyl-2-naphthylamine, octylated diphenylamine, for example p,p′-di-tert-octyidiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis-(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyidiphe-nylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethyl-piperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol.

2. UV absorbers and light stabilisers

2.1. 2-(2′-Hydroxtyphenyl)benzotriazoles, for example 2-(2′-hydroxy-5′-methylphenyl)benzo-triazole, 2-(3′,5′-di-tert-butyl-2′-hydroxyphenyl)benzotriazole, 2-(5′-tert-butyl-2′-hydroxypheyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300; 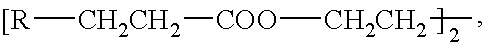
where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]-benzotriazole; 2-[2′-hydroxy-3′-(1,1,3,3-tetramethylbutyl)-5′-(α,α-dimethylbenzyl)phenyl]benzotriazole.

2.2. 2-Hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.

2.3. Esters of substituted and unsubstituted benzoic acids, for example 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4. Acrylates, for example ethyl α-cyano-β,β,-diphenylacrylate, isooctyl α-cyano-β,β-diphenylacrylate, methyl a-carbomethoxycinnamate, methyl α-cyano-β-methyl-p-methoxycinnamate, butyl α-cyano-β-methyl-p-methoxycinnamate, methyl α-carbomethoxy-p-methoxycinnamate and N-(β-carbomethoxy-β-cyanovinyl)-2-methylindoline.

2.5. Nickel compounds, for example nickel complexes of 2,2′-thiobis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyidithiocarbamate, nickel salts of the monoalkyl esters, e.g. the methyl or ethyl ester, of 4-hydroxy-3,5-di-tertbutylbenzylphosphonic acid, nickel complexes of ketoximes, e.g. of 2-hydroxy-4-methylphenylundecylketoxime, nickel complexes of 1-phenyl-4-lauroyl-5-hydroxypyrazole, with or without additional ligands.

2.6. Sterically hindered amines, for example bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-di-chloro-1,3,5-triazine, tris(2,2,6,6-tetramethyl-4-piperidyl)nitrilotriacetate, tetrakis(2,2,6,6-tetra-methyl-4-piperidyl)-1,2,3,4-butanetetracarboxylate, 1,1′-(1,2-ethanediyl)-bis(3,3,5,5-tetrame-thylpiperazinone), 4-benzoyl-2,2,6,6-tetramethylpiperidine, 4-stearyloxy-2,2,6,6-tetramethyl-piperidine, bis(1,2,2,6,6-pentamethylpiperidyl)-2-n-butyl-2-(2-hydroxy-3,5-di-tert-butylbenzyl)-malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylene-diamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, 5-(2-ethylhexanoyl)-oxymethyl-3,3,5-trimethyl-2-morpholinone, 1-(2-hydroxy-2-methylpropoxy)-4-octadecanoyloxy-2,2,6,6-tetramethylpiperidine, 1,3,5-tris(N-cyclohexyl-N-(2,2,6,6-tetramethylpiperazin-3-on-4-yl)amino)-s-triazine, 1,3,5-tris(N-cyclohexyl-N-(1,2,2,6,6-pentamethylpiperazin-3-on-4-yl)amino)-s-triazine, the reaction product of 2,4-bis[(1-cyclohexyloxy-2,2,6,6-piperidin-4-yl)butylamino]-6-chloro-s-triazine with N,N′-bis(3-aminopropyl)ethylenediamine), a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-tri-chloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide; N-(1,2,2,6,6-pentamethyl-4-piperidyl)-n-dodecylsuccinimide; 2-undecyl-7,7,9,9-tetramethyl-1-oxa-3,8-diaza-4-oxo-spiro-[4,5]decane; 5-(2-ethylhexanoyl)oxymethyl-3,3,5-trimethyl-2-morpholinone; a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)-ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine.

2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.

2.8. 2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethyl-phenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1 ,3,5-triazine.

3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide.

4. Phosrhites and phosrhonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-dT-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1 ′-biphenyl-2,2′-diyl)phosphite], 2-ethylhexyl(3,3′,5,5′-tetra-tert-butyl-1,1 ′-biphenyl-2,2′-diyl)phosphite, 5-butyl-5-ethyl-2-(2,4,6-tri-tert-butylphenoxy)-1,3,2-dioxaphosphirane.

The following phosphites are especially preferred:

Tris(2,4-di-tert-butylphenyl) phosphite (Irgafos®168, Ciba-Geigy), tris(nonylphenyl) phosphite,

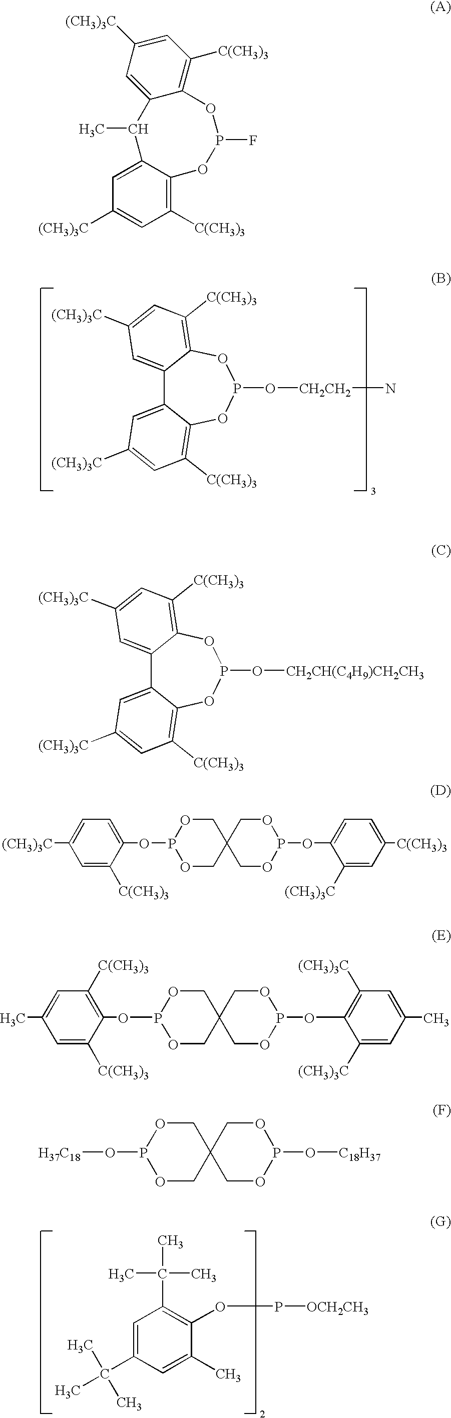

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N, N-dioctadecylhydroxylamine, N-hexadecyl-N-octadecylhydrox-ylamine, N-heptadecyl-N-octadecylhydroxylamine, N,N-dialkylhydroxylamine derived from hydrogenated tallow amine.

6. Nitrones, for example N-benzyl-alpha-phenylnitrone, N-ethyl-alpha-methyinitrone, N-octyl-alpha-heptyinitrone, N-lauryl-alpha-undecylnitrone, N-tetradecyl-alpha-tridecyinitrone, N-hexadecyl-alpha-pentadecyinitrone, N-octadecyl-alpha-heptadecyinitrone, N-hexadecyl-al-pha-heptadecyinitrone, N-ocatadecyl-alpha-pentadecyinitrone, N-heptadecyl-alpha-hepta-decylnitrone, N-octadecyl-alpha-hexadecyinitrone, nitrone derived from N,N-dialkylhydroxyl-amine derived from hydrogenated tallow amine.

7. Thiosynergists, for example dilauryl thiodipropionate or distearyl thiodipropionate.

8. Peroxide scavengers, for example esters of β-thiodipropionic acid, for example the lauryl, stearyl, myristyl or tridecyl esters, mercaptobenzimidazole or the zinc salt of 2-mercapto-benzimidazole, zinc dibutyldithiocarbamate, dioctadecyl disulfide, pentaerythritol tetrakis(β-dodecylmercapto)propionate.

9. Polyamide stabilisers, for example copper salts in combination with iodides and/or phosphorus compounds and salts of divalent manganese.

10. Basic co-stabilisers, for example melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.

11. Nucleating agents, for example inorganic substances, such as talcum, metal oxides, such as titanium dioxide or magnesium oxide, phosphates, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate; polymeric compounds, such as ionic copolymers (ionomers). Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.

12. Fillers and reinforcing agents, for example calcium carbonate, silicates, glass fibres, glass beads, asbestos, talc, kaolin, mica, barium sulfate, metal oxides and hydroxides, carbon black, graphite, wood flour and flours or fibers of other natural products, synthetic fibers.

13. Other additives, for example plasticisers, lubricants, emulsifiers, pigments, rheology additives, catalysts, flow-control agents, optical brighteners, flameproofing agents, antistatic agents and blowing agents.

14. Benzofuranones and indolinones, for example those disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876; EP-A-0589839 or EP-A-0591102 or 3-[4-(2-acetoxyethoxy)-phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one], 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofuran-2-one, 3-(3,4-dimethylphenyl)-5,7-di-tert-butyl-benzofuran-2-one, 3-(2,3-dimethylphenyl)-5,7-di-tert-butyl-benzofuran-2-one.

Preferred compositions of the invention comprise, as other additives, one or more components selected from the group consisting of pigments, dyes, fillers, levelling assistants, dispersants, plasticizers, vulcanization activators, vulcanization accelerators, vulcanizers, charge control agents, adhesion promoters, light stabilizers or antioxidants, such as phenolic antioxidants (items 1.1 to 1.18 in the list) or aminic antioxidants (item 1.19 in the list), organic phosphites or phosphonites (item 4 in the list) and/or thiosynergists (item 7 in the list).

An example of the concentrations at which these other additives are added is from 0.01 to 10%, based on the total weight of the elastomer to be stabilized.

Component b), and also, if desired, other additives are incorporated into the elastomer by known methods, for example during mixing in internal mixers with rams (Banbury), on mixing rolls or in mixing extruders, prior to or during shaping or vulcanization, or else by applying dissolved or dispersed component b) to the elastomer, if desired with subsequent removal of the solvent by evaporation. When added to the elastomer to be stabilized, component b) and, if desired, other additives may also be in the form of a masterbatch comprising these, for example at a concentration of from 2.5 to 25% by weight.

Component b) and, if desired, other additives may also be added prior to or during the polymerization of synthetic elastomers or prior to crosslinking, i.e. advantageously, if desired, as a first-level stabilizer in the crude rubber, which may also comprise other components, such as carbon black as filler and/or extender oils.

The compounds of the formula I are bonded chemically (grafted) to polymer chains under processing conditions (compounding, mixing, vulcanization, etc.). The compounds of the formula I are resistant to extraction, i.e. they continue to offer good protection after the substrate is subjected to intensive extraction. The loss of compounds of the formula I from the elastomer via migration or extraction is extremely slight. The subject of the invention therefore comprises a method of grafting a compound of formula I onto a polymer, which comprises heating, preferably in a processing apparatus for polymers, a mixture of polymer and at least one compound of formula I above the softening point of the polymer and allowing them to react with one another. Preferred temperature range for grafting is 120-200° C., for example 140-180° C., especially 150-170° C.

The elastomers stabilized with the compounds of the formula I also show markedly improved and desirable gloss. This means that the surface gloss of the elastomer stabilized according to the invention, after exposure to ozone, is significantly higher than that of an unstabilized elastomer or of an elastomer stabilized in accordance with the prior art. As further advantage, the use of present compounds of formula I brings about significantly lowered or non-existent contact discoloration (staining).

Component b) and, if desired, other additives may be in pure form or encapsulated in waxes, in oils or in polymers when they are incorporated into the elastomer to be stabilized.

Component b) and, if desired, other additives may also be sprayed onto the elastomer to be stabilized. They are capable of diluting other additives (e.g. the conventional additives given above) or melts of these, and they may therefore also be sprayed together with these additives onto the elastomer to be stabilized.

The resultant stabilized elastomers may be used in a wide variety of forms, e.g. ribbons, moulding compositions, profiles, conveyor belts or tyres (pneumatic).

The present invention further provides a process for stabilizing elastomers to prevent oxidative, thermal, dynamic, light-induced and/or ozone-induced degradation, which comprises incorporating into these or applying to these at least one component b).

The present invention further provides a process for preventing contact discoloration of substrates coming into contact with elastomers, which comprises incorporating into the elastomers, or applying to these, at least one component b).

A further embodiment of the present invention is the use of component b) as stabilizers for elastomers to prevent oxidative, thermal, dynamic, light-induced and/or ozone-induced degradation.

A further embodiment of the present invention is the use of component b) as stabilizers for elastomers to prevent contact discoloration of substrates coming into contact with elastomers.

The preferred compounds of the formula I [component b)] for the processes and uses listed above are the same as those for the compositions of the invention.

The examples below further illustrate the invention. Data in parts or percentages are based on weight. Room temperature stands for a temperature in the range 20-25° C. MS(Cl) denotes mass spectrometry (chemical ionization).

### EXAMPLE 1

### Preparation of the Compound of the Formula 1 B

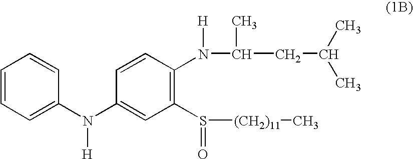 The starting thioether of the formula 1A is prepared according to WO-A-02/42262, Example 3. 4.7 g (0.01 mol) of this thioether 1A and 2 g (0.018 mol) of urea-H₂O₂-adduct (30% H₂O₂) in 8 ml of ethanol are stirred for 6 hours at 40° C. After removal of the excess of hydrogen peroxide by washing of the organic phase with a solution of sodiumpyrosulfate (Na₂S₂O₅), the solvent is removed by distillation. The title sulfoxide 1B is obtained as a brown resin (yield 100%). MS(Cl) 485 (MH⁺).

### EXAMPLE 2

### Preparation of the Compound of the Formula 2B Via Compound of the Formula 2A

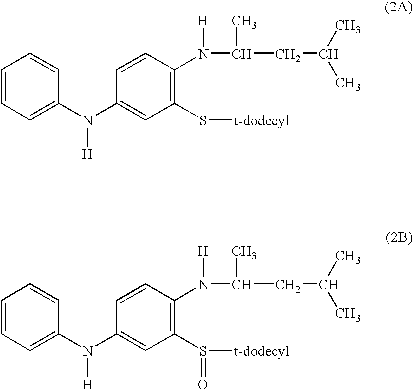 Following the method described in Examples 1-15 of WO-A-02/42262, 3.0 mmol of N-(1,3-dimethylbutyl)-N′-phenyl-p-quinone diimine in 25 ml of ethanol is treated at 20° C. with 3.0 mmol of tert-dodecylmercaptan with stirring. The intermediate 2A is isolated in analogy to Example 3 of WO-A-02/42262 to give a brown oil, yield 59%, MS(Cl) 469(MH⁺). Subsequent oxidation and workup as described above in Example 1 yields the title sulfoxide 2B (74% of theory) as a brown oil, MS(Cl): 485(MH⁺).

### EXAMPLE 3

### Preparation of the Compound of the Formula 3B Via Compound of the Formula 3A

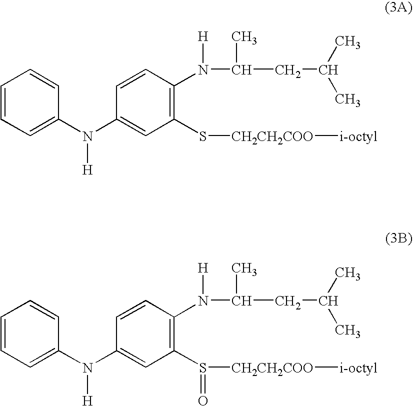 Following the method described in Examples 1-15 of WO-A-02/42262, 3.0 mmol of N-(1,3-dimethylbutyl)-N′-phenyl-p-quinone diimine is reacted with the equimolar amount of the mercaptan HS—CH₂CH₂COO-i-octyl. The intermediate 3A is isolated in analogy to Example 3 of WO-A-02/42262 to give a brown oil, yield 31%, MS(EI) 484(M⁺′). Subsequent oxidation and workup as described above in Example 1 yields the title sulfoxide 3B (95% of theory) as a brown oil, MS(CI): 501 (MH⁺).

### EXAMPLE 4

### Preparation of the Compound of the Formula 4B Via Compound of the Formula 4A

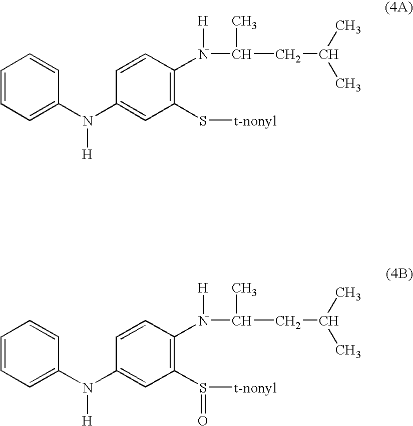 Following the method described in Examples 1-15 of WO-A-02/42262, 3.0 mmol of N-(1,3-dimethylbutyl)-N′-phenyl-p-quinone diimine is reacted with the equimolar amount of tert-nonylmercaptan. The intermediate 4A is isolated in analogy to Example 3 of WO-A-02/42262 to give a brown oil, yield 39%, MS(EI) 426(M⁺). Subsequent oxidation and workup as described above in Example 1 yields the title product 4B (10% of theory) as a brown oil, MS(Cl):443(MH⁺).

### EXAMPLE 5

### Preparation of the Compound of the Formula 5B Via Compound of the Formula 5A

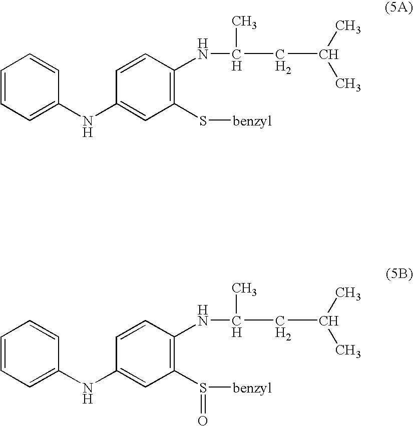 Following the method described in Examples 1-15 of WO-A-02/42262, 3.0 mmol of N′-(1,3-dimethylbutyl)-N′-phenyl-p-quinone diimine is reacted with the equimolar amount of benzyl-mercaptan. The Intermediate 5A is isolated in analogy to Example 3 of WO-AO2/42262 to give a brown, viscous oil, yield 51%, MS(EI) 390(M⁺). Subsequent oxidation and workup as described in above Example 1 yields the title product 5B (61% of theory) as a greenish powder, m.p. 60° C., MS(Cl) 407(MH⁺).

### EXAMPLE 6

### Preparation of the Compound of the Formula 6B Via Compound of the Formula 6A

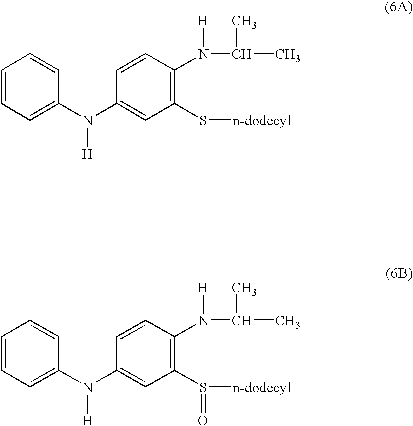 Following the method described in Examples 1-15 of WO-A-02/42262, 3.0 mmol of N-iso-propyl-N′-phenyl-p-quinone diimine is reacted with the equimolar amount of n-dodecanethiol. The intermediate 6A is isolated in analogy to Example 3 of WO-A-02/42262 to give a brownish oil, yield 75%, MS(Cl) 427(MH⁺). Subsequent oxidation and workup as described above in Example 1 yields the title product 6B (80% of theory) as colorless crystals, m.p. 89° C., MS(Cl) 443(MH⁺).

### EXAMPLE 7

### Preparation of the Compound of the Formula 7B Via Compound of the Formula 7A

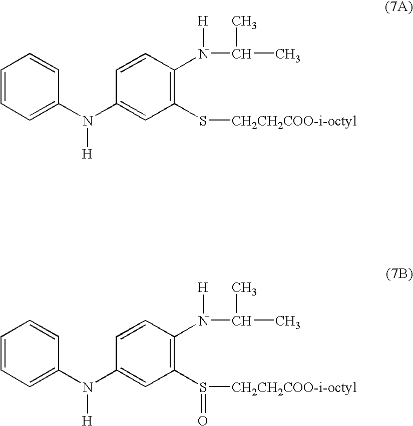 Following the method described in Examples 1-5 of WO-A-02/42262, 3.0 mmol of N-isopropyl -N′-phenyl-p-quinone diimine is reacted with the equimolar amount of n-dodecane-thiol. The intermediate 7A is isolated in analogy to Example 3 of WO-A-02/42262 to give a brown oil, yield 89%, MS(EI) 442(M⁺). Subsequent oxidation and workup as described above in Example 1 yields the title product 7B (95% of theory) as a brown oil, MS(Cl) 459(MH⁺).

### EXAMPLE 8

### Preparation of the Compound of the Formula 8B Via Compound of the Formula 8A

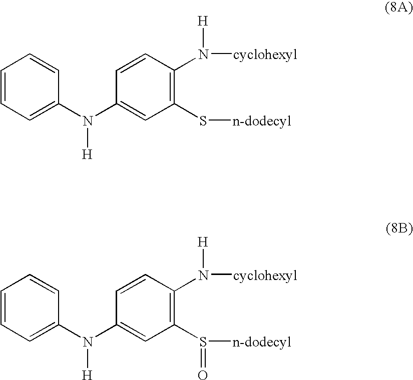 Following the method described in Examples 1-15 of WO-A-02/42262, 3.0 mmol of N-cyclo-hexyl-N′-phenyl-p-quinone diimine is reacted with the equimolar amount of n-dodecanethiol. The intermediate 8A is isolated in analogy to Example 3 of WO-A-02/42262 to give a brown oil, yield 56%, MS(EI) 466(M⁺). Subsequent oxidation and workup as described above in Example 1 yields the title product 8B (84% of theory) as a colorless crystals, m.p. 112° C., MS(Cl) 483(MH⁺).

### EXAMPLE 9

### Preparation of the Compound of the Formula 9B Via Compound of the Formula 9A

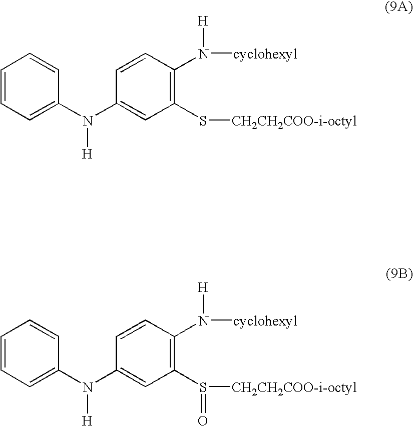 Following the method described in Examples 1-15 of WO-A-02/42262, 3.0 mmol of N-cyclo-hexyl-N′-phenyl-p-quinone diimine is reacted with the equimolar amount of the mercaptan HS—CH₂CH₂COO-i-octyl. The intermediate 9A is isolated in analogy to Example 3 of WO-A-02/42262 to give a brown oil, yield 54%, MS(EI) 482(M⁺). Subsequent oxidation and workup as described above in Example 1 yields the title product 9B (100% of theory) as a brown oil, MS(EI) 498(M⁺).

### EXAMPLE 10

### Preparation of the Compound of the Formula 10B via compound 10A

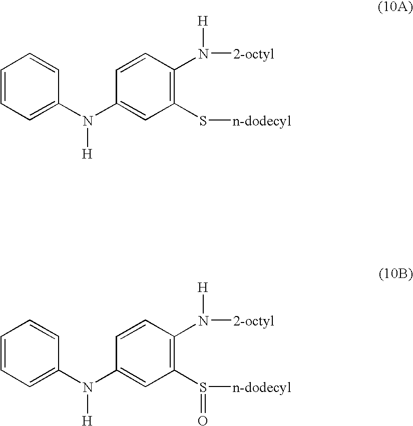 Following the method described in Examples 1- 15 of WO-A-02/42262, 3.0 mmol of N-(2-octyl)-N′-phenyl-p-quinone diimine is reacted with the equimolar amount of n-dodecane-thiol. The intermediate 10A is isolated in analogy to Example 3 of WO-A-02/42262 to give a brown oil, yield 72%, MS(EI) 496(M⁺). Subsequent oxidation and workup as described above in Example 1 yields the title product 10B (100% of theory) as a brown oil, MS(Cl) 513(MH⁺).

### EXAMPLE 11

### Preparation of the Compound of the Formula 11B Via Compound 11A

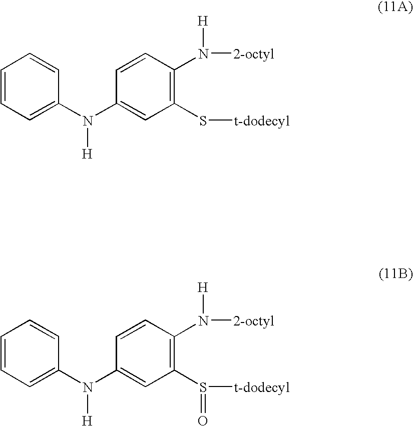 Following the method described in Examples 1-15 of WO-A-02/42262, 3.0 mmol of N-(2-octyl)-N′-phenyl-p-quinone diimine is reacted with the equimolar amount of t-dodecane-thiol. The intermediate 11A is isolated in analogy to Example 3 of WO-A-02/42262 to give a brown oil, yield 57%, MS(EI): 496(M⁺). Subsequent oxidation and workup as described above in Example 1 yields the title product 11 B (24% of theory) as a brown oil, MS(Cl) 513(MH⁺).

### EXAMPLE 12

### Preparation of the Compound of the Formula 12B Via Compound 12A

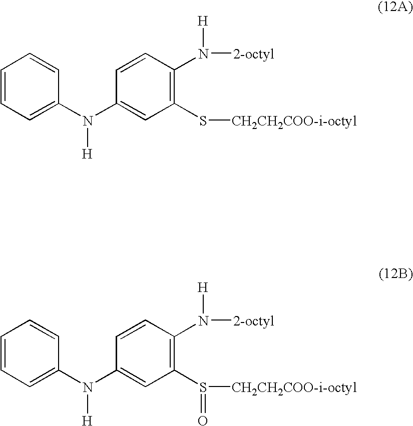 Following the method described in Examples 1-15 of WO-A-02/42262, 3.0 mmol of N-(2-octyl)-N′-phenyl-p-quinone diimine is reacted with the equimolar amount of the mercaptan HS—CH₂CH₂COO-i-octyl. The intermediate 12A is isolated in analogy to Example 3 of WO-A-02/42262 to give a brown oil, yield 54%, MS(Cl) 513(MH⁺). Subsequent oxidation and workup as described above in Example 1 yields the title product 12B (100% of theory) as a brown oil, MS(Cl) 529(MH⁺).

### EXAMPLE 13

### Stabilization of Black Vulcanizate

40.0 parts by weight of Cariflex® 1220 [polybutadiene, SHELL] are processed on mixing rolls at 60° C. with 60.0 parts by weight of natural rubber and 55.0 parts by weight of carbon black (N 330), 6.0 parts by weight of Ingralen 450 (RTM) [extender oil], 5.0 parts by weight of zinc oxide [vulcanization activator], 2.0 parts by weight of stearic acid [vulcanization activator], 0.2 parts by weight of IRGANOX 1520 (RTM) [processing stabilizer, Ciba Specialty Chemicals], 2.0 parts by weight of sulfur [vulcanizer], 0.6 part by weight of Vulkacit MOZ (RTM) [vulcanization accelerator, BAYER] and 1.5 parts by weight of the stabilizer to be tested according to Tables 1, 2 and 3, to give a homogeneous mixture, the vulcanization system [sulfur and Vulkacit MOZ (RTM)] not being added until the end of the mixing process. The mixture is vulcanized in electrical heating presses at 150° C. to T95 on the rheometer curves, to give elastomer sheets of 2 mm thickness, 21 cm length and 8.0 cm width. Sections of the 2 mm rubber sheets are placed on a white cardboard underlay and stored in a circulating-air cabinet at 50° C. for 5 days. The contact surface or its margin is then evaluated visually for contact discoloration (staining): 0 =no discoloration (or the discoloration of the reference in which no AO is present) and 5 =greatest degree of discoloration. The results are summarized in Table 1.

TABLE 1

| Example | Stabilizer | Staining (4 weeks) |
|---|---|---|
| 13a^{b)} | 1B | 0 |
| 13b^{b)} | 2B | 0 |
| 13c^{b)} | 3B | 0 |
| 13d^{b)} | 4B | 0 |
| 13e^{b)} | 6B | 0 |
| 13f^{b)} | 8B | 0 |
| 13g^{b)} | 10B | 0 |
| 13h^{b)} | 11B | 0 |
| 13i^{a)} | Vulkanox 4020^{c)} | 5 |
| 13k^{a)} | Vulkanox 4010^{d)} | >3 |
| 13l^{a)} | UOP688^{e)} | >2 |
| 13m^{a)} | Flexzone 6H^{f)} | >4 |

^{a)}Comparative example.
^{b)}Example according to the invention.
^{c)}Vulkanox 4020 (RTM) [Bayer] is 4-(1,3-
dimethylbutyl)aminodiphenylamine of the formula A.

| | |
|---|---|
| 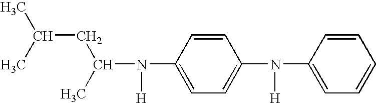 | (A) |

^{d)}Vulkanox 4010 (RTM([Bayer] is 4-(2-propylamino)diphenylamine of
formula B.

| | |
|---|---|
| 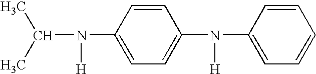 | (B) |

^{e)}UOP 688 (RTM) [UOP] is 4-(2-octylamino)diphenylamine of formula C.

| | |
|---|---|
| 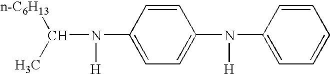 | (C) |

^{f)}Flexzone 6H (RTM) [Flexsys] is 4-cyclohexlyaminodiphenylamine of
formula D

| | |
|---|---|
| 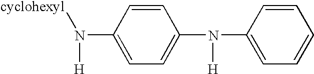 | (D) |

Determination of the grafting rate: In order to test the extraction resistance of the compounds according to the invention, the 2mm plates were treated in a Soxhiet extractor for 72 hours in acetone. The non-extractable portion of additive was determined by nitrogen analysis with allowance for extractable and extraction-stable nitrogen from other components of the mixture. The results are summarized in Table 2.

TABLE 2

| | | Non-extractable |
|---|---|---|
| Example | Stabilizer | additive^{g)} [%] |
| 13a^{a)} | 1A | 0 |
| 13b^{b)} | 1B | 5 |
| 13c^{a)} | 2A | 0 |
| 13d^{b)} | 2B | 47 |
| 13e^{a)} | 3A | 0 |
| 13f^{b)} | 3B | 32 |
| 13g^{a)} | 4A | 0 |
| 13h^{b)} | 4B | 48 |
| 13i^{a)} | 6A | 0 |
| 13j^{b)} | 6B | 18 |
| 13k^{a)} | 8A | 0 |
| 13l^{b)} | 8B | 11 |
| 13m^{b)} | 11B | 48 |
| 13n^{a)} | Vulkanox 4020^{c)} | 0 |

^{a)}Comparative example.
^{b)}Example according to the invention.
^{c)}see footnote at end of Table 1.
^{g)}by nitrogene analysis, after Soxhlet extraction with acetone (72 h).

Oxidation protection of extracted samples: To ascertain the effect of the grafted additives hot air ageing in a multi-cell oven (DIN 53508) was carried out with extracted specimens. The anti-oxidative effect of the additives was determined by tensile tests with ISO S2 dumb-bells (DIN 53504). The higher the tensile strength the better the protection. The results are summarized in Table 3.

TABLE 3

| | | Tensile strength [MPa] of |
|---|---|---|
| | | extracted samples after |
| Example | Stabilizer | 2 weeks oven aging at 80° C. |
| 13a^{a)} | 1A | 4.9 |
| 13b^{b)} | 1B | 6.4 |
| 13c^{a)} | 2A | 6.2 |
| 13d^{b)} | 2B | 8.3 |
| 13e^{a)} | 3A | 5.3 |
| 13f^{b)} | 3B | 8.9 |
| 13g^{a)} | 4A | 6.1 |
| 13h^{b)} | 4B | 10.8 |
| 13i^{b)} | 5B | 6.6 |
| 13j^{a)} | 8A | 5.4 |
| 13k^{b)} | 8B | 7.9 |
| 13l^{a)} | Vulkanox 4020^{c)} | 5.3 |

Explanations of footnotes ^{a)},^{b)} and ^{c)} see end of Table 1.

1. A compound of the formula I 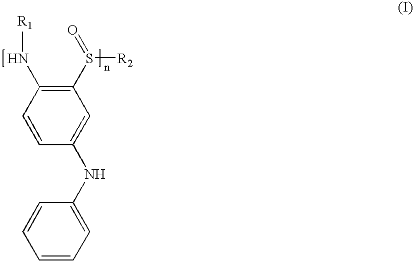
wherein
R₁ is C₁-C₁₈alkyl, C₅-C₁₂-cycloalkyl, phenyl, benzyl, or allyl;
n is 1 or 2;
if n is 1, R₂ is C₄-C₁₈alkyl, C₅-C₁₂-cycloalkyl, aryl or heteroaryl, benzyl, allyl, (CH₂)ₘCOOR₃, or is (CH₂)ₘCN;
if n is 2, R₂ is —S—(CH₂)ₚ—S or —S—(CH₂)₂—[O—(CH₂)₂]ₘ—S—
R₃ is C₁-C₁₈alkyl, benzyl, allyl;
m is 1 or 2; and
p is a number from 2 to 12.

2. Compound of formula I according to claim 1 wherein
R₁ is C₂-C₈-alkyl, cyclohexyl, phenyl, benzyl, or allyl,
if n is 1, R₂ is C₄-C₁₈alkyl, cyclohexyl, benzyl, phenyl, (CH₂)₂COOR₃, or is (CH₂)₂CN;
if n is 2, R₂ is —S—(CH₂)ₚ—S or —S—(CH₂)₂—[O—(CH₂)₂]ₘ—S—;
R₃ is C₁-C₁₈alkyl; and
p is a number from 2 to 6.

3. A composition comprising
a) a naturally occurring or synthetic elastomer susceptible to oxidative, thermal, dynamic, light-induced and/or ozone-induced degradation, and
b) as stabilizer, at least one compound of the formula I according to claim 1.

4. A composition according to claim 3, in which component a) is a natural or synthetic rubber or a vulcanizate prepared therefrom.

5. A composition according to claim 4, in which component a) is a polydiene vulcanizate, a halogen-containing polydiene vulcanizate, a polydiene copolymer vulcanizate or an ethylene-propylene terpolymer vulcanizate.

6. A composition according to claim 3, further comprising one or more components selected from the group consisting of pigments, dyes, fillers, levelling assistants, dispersants, plasticizers, vulcanization activators, vulcanization accelerators, vulcanizers, charge control agents, adhesion promoters, antioxidants, flame retardants, UV absorbers and light stabilizers, phenolic antioxidants, aminic antioxidants, organic phosphites or phosphonites and thiosynergists.

7. A thioether of formula II′ 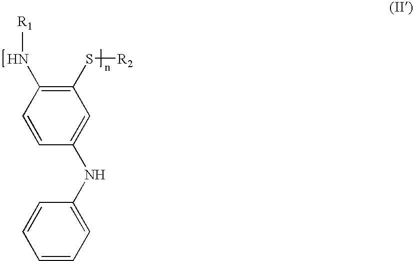
wherein n is 1 or 2,
R₁ is C₁-C₁₈alkyl, C₅-C₁₂-cycloalkyl, phenyl, benzyl, or allyl; and
R₂, if n is 1, is tert-nonyl or tert-dodecyl or (CH₂)₂COOR₃ or (CH₂)₂CN, where R₃ is C₁-C₁₈alkyl,
R₂, if n is 2, is —S—(CH₂)ₚ—S— with p ranging from 2 to 6; with the proviso that the compound of the formula II′a 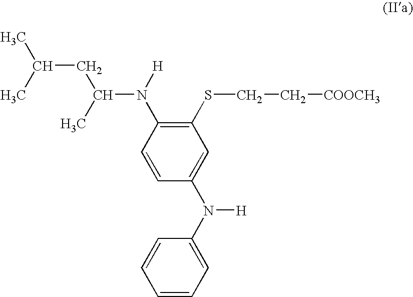
is excluded.

8. A method of grafting a compound of formula I according to claim 1 onto an elastomer, which method comprises heating a mixture of elastomer and at least one compound of formula I above the softening point of the elastomer and allowing them to react with one another.

9. (canceled)

10. A process for stabilizing an elastomer to prevent oxidative, thermal, dynamic, light-induced and/or ozone-induced degradation and preventing contact discoloration of substrates coming into contact with the elastomer, which process comprises incorporating into these or applying to these at least one compound of formula I according to claim 1.

11. A composition comprising according to claim 3 where the at least one compound of the formula I is present in an amount from 0.05 to 10%, based on the weight of component a).

12. A thioether of formula II′ according to claim 7 where R₂, if n is 1, is tert-nonyl or tert-dodecyl or (CH₂)₂COOR₃ or (CH₂)₂CN, where R₃ is i-octyl, i-tridecyl, n-dodecyl or stearyl.
